(19) United States
(12) Patent Application Publication
(10) Pub. No.: US 2016/0143296 A1
(43) Pub. Date: May 26, 2016

(54) METHOD AND APPARATUS FOR PRODUCING WAFER SHAPED BODIES BAKED UNDER PRESSURE

(71) Applicant: HAAS FOOD EQUIPMENT GMBH, Wien (AT)

(72) Inventors: JOHANNES HAAS, WIEN (AT); JOSEF HAAS, LEOBENDORF (AT); STEFAN JIRASCHEK, KOENIGSBRUNN (AT); KARL TIEFENBACHER, WIEN (AT); MARKUS BIBARIC, KIERLING (AT)

(21) Appl. No.: 14/897,302

(22) PCT Filed: Jun. 2, 2014
(86) PCT No.: PCT/EP2014/061314

§ 371 Date: Dec. 10, 2015

(30) Foreign Application Priority Data
Jun. 10, 2013 (AT) A 466/2013

(51) Int. Cl. A21B 5/02; A21D 13/00; A21D 8/06

(52) U.S. Cl. CPC A21B 5/02; A21D 8/06; A21D 13/008

(57) ABSTRACT

The invention relates to an apparatus, baking oven and method for producing a wafer shaped body (2), in particular a baked intermediate product comprising a baking mass baked under pressure, preferably containing 55-70% water in the unbaked state, comprising a baked product (20) having a baked product thickness (21) which is surrounded by a baking linkage (19), wherein the baking linkage (19) at least comprises a rib (22), which extends as far as the edge of the baked product (20).

The invention relates to a baking plate apparatus, a baking oven, a wafer shaped body and a method for producing the wafer shaped body.

### FIELD OF THE INVENTION

Many relaxed baked goods have two characteristic elements:
1. A largely closed and smooth surface caused by the formation of a crust during the baking.
2. A porous inner structure which is attributable to a loosening by raising agent gases and steam.

Examples of this are baked goods from the areas of bread, pastries or patisserie where, by forming a baking skin and gelatinizing the starch by means of steam and hot air, a closed, frequently smooth and shiny surface crust is formed having completely different properties from that of the soft porous crumb in the interior.

Other examples with significant structural differences between surface and core region are wafer baked goods baked under pressure such as flat wafers, hollow wafers and wafer containers. Here in direct contact with the hot baking mould, initial baking takes place immediately during filling of the baking mould and a baking skin having a largely closed appearance forms, whereas the wafer interior has a particularly open and porous structure as a result of extensive steam loosening, which is based on the particularly high water content of wafer baking compounds compared to other baked goods, this being 55 to 66%. This not very dense, large-pored inner structure is also responsible for the very low density of flat wafers, hollow wafers and wafer containers, which is only about 0.15 g/cm³.

If in the course of the further processing of loosened baked products it is necessary to divide these by means of separating cuts, the open porous structure is fully visible in the cut region. This naturally also has more unfavourable technological properties than the closed outer skin such as possibly a severely increased crumbling or break-out or a rapid soaking up of liquid or pasty components when these are combined with the cut open edge of the baked goods. Furthermore, the inclusion of air takes place so that when covering with warm glazes, a bursting of the incipient bubble takes place as a result of thermal expansion, which leaves behind an unattractive hole in the coating. An essential protective function of such coatings to reduce the ingress of oxygen from the air and/or moisture is thus significantly reduced.

The invention relates in particular to a new baking technology process for producing hollow body wafer shells in modified hollow wafer and flat wafer baking moulds. After the baking process, the baked hollow body wafer half-shells can be separated in a simple mechanical process. The methods used hitherto to separate the hollow body wafer half-shells such as horizontal cutting-off, grinding-off, milling-off, planing-off or vertical punching-out or sawing-out are no longer necessary. At the same time, the technologically disadvantageous wide open-pored porous edges are avoided with the new process.

The production of baked wafers as flat wafer sheets, hollow wafer sheets, wafer cups or wafer cones in closed metal baking moulds with steam escape openings has been prior art for a long time. However, all these products have two characteristic features in common in each case.
1. A largely closed baking skin on all outer sides,
2. A largely homogeneous wafer thickness in the region of continuously about 0.5 mm to about 5 mm, the latter when the continuous core region which is typically 0.5 to 2 mm thick is extended by engravings.

### Ad. 1. Closed Baking Skin on the Outer Sides or Open Large-Pore Edge

The products obtained during wafer baking have a denser, smooth closed baking skin on all sides, even on the narrow edges, at best with small openings which mark the steam outlet openings. These products therefore all have a baked and therefore visually largely closed edge.

In addition, over the years methods have been established for the production of wafer pralines in which after the baking of the hollow wafer sheets the baking linkage between the hollow moulds remaining as wafer half-shells is removed by either horizontal cutting-off, grinding-off, milling-off, planing-off or by vertical punching-out or sawing out. The wafer half-shells thus obtained then have in the separating region an open, large-pore edge surrounding the entire wafer cross-section without the closed baking skin. Such open edges are on the one hand visually unattractive, on the other hand they naturally have more unfavourable technological properties than the closed outer skin. Thus, for example, a substantially increased crumbling or break-out or a rapid soaking up of liquid or pasty components occurs when these are combined with the cut open edge of the baked goods. Furthermore, the inclusion of air takes place so that when covering with warm glazes, a bursting of the incipient bubble takes place as a result of thermal expansion, which leaves behind an unattractive hole in the coating. An essential protective function of such coatings to reduce the ingress of oxygen from the air and/or moisture in the consumption time is thus significantly reduced.

For economic reasons this second technique of open edges is widely used since the individual baking of hollow body wafer half-shells with closed edges requires a large number of individual baking moulds compared to baking in hollow wafer sheets, which results in a significantly higher investment and space requirement.

Ad. 2. Homogeneous Wafer Thickness with 1 to 2 mm Core Region, Up to 5 mm Overall Thickness Over Engravings

The wafer (sheet) thickness specifies the size of the open edge. Prior art is a homogeneous thickness. According to the prior art, a baking linkage in normal thickness is deemed necessary for the removal of the high water fractions of 55 to 65% in the wafer baking masses as steam. In hollow wafer sheets, baking linkage is understood as the wafer material which is located in the wafer sheet e.g. between the hollow body wafer half-shells.

Apparatus, in particular baking ovens for producing crispy brittle flat wafers or hollow wafers can be deduced from the prior art. In these ovens openable and closable baking tongs are guided through a heated baking chamber of a baking oven. The crispy brittle consistency of the baked products results from the effect that baking masses or batter having a high water fraction of about 50-70% are baked under high pressure. In this case the water of the baking mass escapes very rapidly in the form of steam and leaves behind a porous, brittle structure. A locking apparatus is provided in order to be able to carry out the baking process at high pressure. The baking tong can be locked by means of this apparatus so that a positive pressure can build up in the interior. The desired baking profile can only be achieved through this positive pressure.

Sufficient free space must exist between upper and lower plate so that the steam can escape laterally from the baking tong. The steam in the interior of the wafer shaped body is guided outwards according to the prior art. The layer of the wafer shaped body adjacent to the heated baking surface undergoes almost no steam diffusion during baking. As a result, a substantially closed and smooth surface is formed in the contact region between the baking plate and the wafer shaped body. This surface is small-pore compared to the porous, large-pore inner structure, for example, of the core of the wafer and as a result on the one hand is visually more attractive and on the other hand is more resistant to the ingress of moisture or other migrating substances.

During the production of crispy brittle wafers there is a very sensitive relationship between the composition of the baking mass, the baking temperature, the baking time and in particular the thickness of the wafer sheet. The thinner is the wafer sheet, the faster this is baked. If wafer sheets are overbaked, this results in an undesired brown colouration and in an excessively brittle dry consistency of the wafer. Since the entire wafer sheet is guided through the baking chamber in a single baking tong, there is no possibility of exposing different baking zones to different temperatures. For this reason, according to technical knowledge wafer sheets are exclusively manufactured with largely constant thickness. This means that at least the core thickness of the wafer sheet is approximately constant over the entire surface. In conventional wafer sheets a relief-like structure, in particular a wafer engraving can be provided.

Usually the wafer shaped bodies are cut in a separating process following the baking process and previously possibly filled with creams such as, for example, chocolate creams. By cutting the wafer sheets, the wafer sheet is opened in the cut region so that a porous large-pore surfaces faces outwards. This surface has the afore-said disadvantages. In particular, moisture can penetrate through the pores which then has the result that the wafer loses its crispy brittle texture and in particular becomes chewy or soft.

It is now the object of the invention to provide a baked product which has a substantially closed smooth surface. In particular it is the object of the invention to provide a baked product in which the surface having a large-pore, porous structure is minimized. A further object of the invention is to manufacture such a product efficiently. This includes the fact that the baked product can be produced on conventional baking ovens to manufacture crispy brittle wafers. Furthermore this means that the waste, e.g. the baking linkage to be separated is minimized and that a high throughput can be achieved during production. This preferably comprises the fact that several baked products can be produced at the same time in one baking tong. The object according to the invention is solved by the feature combination of the independent patent claims.

The baking plate apparatus according to the invention, in particular the baking tongs according to the invention, comprising a pair of baking plates, to produce wafer shaped bodies baked under pressure, such as in particular brittle flat wafers or hollow wafers from a wafer batter, preferably comprises a first baking plate having a first baking surface, a second baking plate having a second baking surface, a movement apparatus by which means the first baking plate is connected to the second baking plate in an openable and closable manner, a locking apparatus for locking the first baking plate to the second baking plate in the closed position, wherein in the closed position a baking mould is formed by the first baking surface and the second baking surface which substantially corresponds to the negative form of the wafer shaped body, and wherein the baking mould comprises a product space with a product thickness, which is surrounded by a gap section with a gap thickness, wherein the gap thickness is smaller than the product thickness, wherein at least one channel having a channel thickness is provided for removal of steam, which is penetrated by the gap section, wherein the channel thickness is greater than the gap thickness. Preferably a plurality of product spaces are provided in a baking plate apparatus.

Further features according to the invention can be that the channel extends from the product space as far as the outer side of the baking plate or the pair of baking plates and thereby opens the product space towards the outside, that two or more product spaces are provided and that the channel extends from one product space to another product space and thereby connects two product spaces with one another, that the channel penetrates the gap section along the first baking surface and/or along the second baking surface, that the channel is provided as a linear engraving in one or in both baking surfaces, wherein the linear engraving crosses at least one gap section, that the gap section has a gap thickness which is less than 50% of the product thickness, preferably less than 30% of the product thickness, and/or that the gap thickness is zero at least in sections, that the gap section extends flat between the product spaces and/or between one product space and the outer side of the pair of baking plates, that two product spaces are connected to one another via a gap section, that a plurality of channels open into one product space, that a plurality of channels are combined in the gap section, that a plurality of channels distributed substantially regularly on the circumference of the product space open into the product space, that the channels run obliquely with respect to one another so that the baked wafer shaped body has a stable structure and/or that a substantially closed comb constricting the product space is provided in the product space so that the baked wafer shaped body has a pre-determined breaking line for separation of the baked product from the baking linkage.

The wafer shaped body, in particular the baked intermediate product comprising a baking mass baked under pressure, preferably in the unbaked state and/or possibly containing 55-70% water, comprising a baked product having a baked product thickness which is surrounded by a baking linkage is preferably executed according to the invention in such a manner that the baking linkage comprises at least one rib which extends as far as the edge of the baked product.

Further advantageous features can be that the baking linkage comprises a connecting lamella with a lamella thickness, that the lamella thickness is at least 50% smaller than the baking product thickness, preferably at least 70% smaller than the baking product thickness or optionally is zero at least in some sections, that the rib runs in the surface or in that of the connecting lamella, that the rib extends from the baking product as far as the edge of the wafer body, that a plurality of ribs are provided which, distributed substantially regularly on the circumference of the baked product, open into the baked product, that a pre-determined breaking line surrounding the baked product is provided, which has a smaller thickness than the baked product, that a plurality of baked products are provided which are connected to one another by the baking linkage, that at least one rib is provided which connects two baked products to one another, that the baked product has a baked product thickness of about 0.5 mm to 5 mm, wherein the continuous core region has a thickness of about 0.5 mm to 2 mm, and/or that the regions of smaller thickness such as in particular the connecting lamella and/or the pre-determined breaking line have a higher degree of baking than the baked product, and in particular are overbaked and/or that the regions having a higher degree of baking are more brittle than the baked product. Preferably a wafer shaped body contains a plurality of baked products.

The baking oven according to the invention for producing preferably crispy-brittle baked wafer shaped bodies can be designed in such a manner that the baking oven has a baking chamber and an endless baking tong chain which circulates continuously in the baking oven and moves through the baking chamber, which is arranged along an orbit which is closed in itself, which extends in two transport planes arranged one above the other, wherein the baking tong chain contains openable and closable baking tongs which can be locked in the closed state, in which baking moulds consisting of baking mould upper parts and baking mould lower parts are disposed, which are opened by opening the baking tongs and are closed by closing the baking tongs, wherein a device for opening the baking tongs, a discharge station, a feeding station, a device for closing the baking tongs and a locking apparatus for locking the baking tongs in the closed state are arranged one behind the other in the running direction of the baking tongs, wherein a product removal apparatus which removes the baked wafer shaped body from the opened baking tongs is provided in the discharge station and that the baking tong is executed as a baking plate apparatus according to any one of the preceding claims.

The method according to the invention for producing crispy-brittle baked products comprising in particular the following steps:

Metering wafer baking masses in particular in linear pouring or with centrally oriented point pourings into the baking mould of a baking plate apparatus according to any one of the preceding claims of a baking oven according to any one of the preceding claims,

Baking and demoulding the wafer shaped bodies according to any one of the preceding claims by in particular blowing out and removing or vacuum removal methods,

Separating the baked product from the baking linkage along the predetermined breaking line and/or optionally for separating the baked product from the baking linkage the wafer shaped body is supplied to a separating apparatus which comprises a separating mould which contacts the wafer shaped body at least in the region of the predetermined breaking lines and/or that then the baked products are separated by one or more stamps which bring about a relative movement between baked product and baking linkage.

According to a prejudice of the technical world, it is not possible to produce wafer sheets in a conventional baking process in which the regions of the baked product are thicker than the regions between the baked products. The predominant technical view is that with a thinner baking linkage the steam cannot escape sufficiently rapidly completely from the baked products.

In the method according to the invention in the apparatus according to the invention, a wafer shaped body is produced. The wafer shaped body is optionally an intermediate product to produce a baked product. The wafer shaped body comprises at least one baked product which is surrounded by a baking linkage. Optionally a plurality of baked products can be provided which are each surrounded by a baking linkage and in particular are connected by the baking linkage.

The baked product has a baked product thickness. The baking linkage comprises at least one, preferably a plurality of ribs and at least one, preferably a plurality of connecting lamellae. The connecting lamellae have a lamella thickness which is smaller than the baked product thickness of the baked product. The baked product is therefore surrounded by thin connecting lamellae. In particular, the surfaces of the baked product are combined in the edge region and run further as the surface of the connecting lamellae. As a result of the thin design of the lamella, the open-pore separating surface is smaller during separation of the baking linkage. With a very thin configuration of the connecting lamella, the surface content of the open-pore separating surface can be almost zero with the result that a completely closed surface exists in the transition region between connecting lamella and baked product.

The production of the wafer shaped body according to the invention is made possible by the baking plate apparatus according to the invention. The baking plate apparatus which in particular is configured as baking tongs comprising a pair of baking plates comprises a first baking plate having a first baking surface and a second baking plate having a second baking surface. Both baking plates are connected to one another by a movement apparatus so that the first baking plate is connected to the second baking plate in an openable and closable manner. The baking plate apparatus further comprises a locking apparatus for the rigid connection of the first baking plate to the second baking plate in the closed position. In particular, the locking apparatus is adapted to prevent an opening of the first baking plate with respect to the second baking plate due to the high pressure of the out flowing steam.

By folding together and closing the baking plates, a baking mould is formed by the two baking surfaces. This baking mould substantially corresponds to a cavity which is filled by the baking mass, e.g. the wafer batter. The baking mould substantially corresponds to the negative mould of the wafer shaped body to be formed.

The baking mould comprises a plurality of sections:

On the one hand, the baking mould comprises a product space with a product thickness. This product space substantially corresponds to the negative mould of the baked product to be formed. The product thickness is substantially constant over the entire profile of the product space so that a uniformly baked product is formed. However slight deviations of the product thicknesses are possible.

The baking mould further comprises a gap section with a gap thickness. The gap thickness is considerably smaller than the product thickness. The gap section surrounds the entire product space. In particular the gap section extends flat around the product space. As a result of the severely reduced thickness of the gap section compared with the product space, a precaution must be taken to remove the steam escaping during baking.

To this end the baking mould comprises channels for removal of steam. These channels are in particular designed as engravings in one or in both baking plates. These channels pass through the gap section. This means that the channels extend away from the product space. In particular, the channels extend as far as the outer side of the baking plate apparatus so that the steam can escape towards the outside. According to a further configuration of the invention, the channels can also be designed as bores.

If a plurality of product spaces are provided in the baking mould, the channels can also extend from product space to product space and thereby connect two product spaces. However preferably each product space is connected to a channel which leads to the outside.

As a result of the configuration of the baking plates and the wafer shaped body according to the invention, the prejudice of the technical world is overcome that the wafer sheet must have substantially a constant core thickness. This is in particular achieved whereby the thinner regions between the baked products are interspersed with channels for removal of steam.

However, the channels of the baking mould bring about a further advantage of the invention. A rib is thus formed by the channels in the wafer shaped body. This rib serves on the one hand to remove the steam during baking and furthermore as a stiffening element of the finish-baked wafer shaped body.

The wafer shaped body is removed from the baking tongs after the baking process. Preferably the wafer shaped body should remain in one piece during removal and not break. As noted, ribs are provided to increase the stability of the wafer shaped body. These ribs are preferably disposed in such a manner that no unintentional pre-determined breaking points are formed. To this end, the ribs are in particular disposed obliquely with respect to one another, crossing one another and/or cross-linked.

A preferred form of removal is a specific grasping of the baked body by means of vacuum suction and its withdrawal from the baking chamber and placement on a conveyor belt in a known manner.

For efficient removal of steam a plurality of channels can open into a product space. In particular, a plurality of channels distributed regularly on the circumference can open into the product space. As a result, the pressure or the steam can escape uniformly and/or in equal parts in several directions. The channels can be combined in the region of the gap section and lead outwards in the form of thicker manifolds. These thicker manifolds in turn bring about thicker ribs. These contribute further to increasing the stability of the wafer shaped body.

The gap sections with smaller gap thickness form a connecting lamella on the wafer shaped body. This surrounds the baked product. Ribs run in the connecting lamella and/or in the surface of the connecting lamella. The connecting lamella has a lamella thickness which is significantly smaller than the baked product thickness of the baked product. As a result, the connecting lamella is overbaked during the conventional baking process. Due to the overbaking of the lamella this is more brittle and more unstable than the baked product. Due to this instability the connecting lamella can advantageously be more easily separated from the baked product.

Due to the transition of the relatively thick baked product to the relatively thin lamella, a pre-determined breaking point and/or a pre-determined breaking line is formed in this region. Along this line simple separation of the baked product to be produced from the baking linkage can be achieved.

Optionally the baking plates or the product space comprise a constricting comb in its edge region which forms a pre-determined breaking line in the wafer shaped body during baking. This is preferably closed substantially circumferentially and defines the side edge of the baking product to be produced.

The channels can open into the region outside the constricting comb or pass through the comb. In both cases, by definition the channels open into the product space.

In order to separate the baked products from the baking linkage, according to the present invention the wafer shaped body can be removed from the baking tongs and supplied to a separating device in a further step. The wafer shaped body is placed in this separating device. Subsequently the baked products are separated from the baking linkage. This is accomplished, for example, by relative movement of the baking linkage and the product. To this end, for example, the wafer shaped body can be placed on a mould which contacts the wafer shaped body in particular in the region of the pre-determined breaking lines. The baking linkage can then be removed by a stamp. Alternatively to this, the stamp itself can move the baking products in order to break them from the baking linkage.

The invention relates in particular to a baking method for baking products such as, for example, hollow wafer half-shells which firstly avoids the visually and technologically disturbing wide large-pore edges and secondly makes the baked products such as, for example, hollow wafer half-shells mechanically easier to separate. The findings associated with the new method are now explained in detail.

It has surprisingly been found that for the baking of wafer shaped bodies such as, for example, wafer sheets, i.e. the rapid removal of the water contained in the baking mass within the usual short baking times of about 2 minutes, it is by no means necessary to make the entire baking linkage between the baked products such as, for example hollow-body wafer half-shells or the separating webs in figures in flat wafer sheets, thicker or at least the same thickness as the thickness of the baked products. In the prior art it has so far been assumed that this is necessary in any case for the rapid removal of the steam.

According to the invention, this baking linkage can be made very thin, in the region of a thickness of less than 0.1 mm. This is however only the case when thicker channels such as material bridges, engraving lines or webs are present in the baking linkage, of which individual ones extend as far as the edge of the baked products. This is achieved whereby in the first baking phase these channels, e.g. the engraving lines are already sufficient as thicker places for the removal of the main quantity of steam during the steam pressure peak. It is known that the steam pressure peak occurs about 10 to 15 seconds after the closure of a wafer sheet baking mould and lasts about 20 to 30 seconds. In this phase, most of the steam generated from the water fraction of the baking mass escapes. The baking of baked products such as, for example, hollow wafer half-shells with very good shaping and lower residual moisture with such thin baking linkages in the wafer sheet completely contradicts the expectations of the technical world.

The thin baking linkage is moreover significantly overbaked as a result of the locally small amount of material, which can also be identified from the more severe browning. Such overbaking is associated with an extreme brittleness. This circumstance significantly simplifies the separation of the normally thick baked products such as, for example, hollow wafer half-shells or flat wafer figures, from the baking linkage or at the separating lines after the demoulding. Controlled light mechanical counter-pressure on the contours is already sufficient for a clean separation.

Depending on the cross-section of the channels or the ribs, demoulding of the sheets as a whole after baking by means of gravity is nevertheless possible. Preferably however, demoulding is also carried out with the aid of the vacuum method.

According to a preferred embodiment, the ready-separated baked products have only a thin visually non-striking open edge line. Hollow wafer half-shells produced in such a manner can therefore be used directly as individual containers.

Pre-moulded flat wafer pieces with a visually largely closed edge after the separation of the pieces or separation of any baking linkages are also produced with the same technique.

Subsequently the method according to the invention is further described by reference to two embodiments:

### FIRST METHOD EXAMPLE

### Hollow Wafer Half-Shells with Closed Edge

a. Preparation of hollow wafer baking moulds for conventional hollow wafer sheet automatic baking machines in which the so-called baking linkage between the one, two or more hollow wafer moulds attached in the baking plate is significantly thinner than hitherto usual, preferably more than 70% thinner. The gap section for the baking linkage can be designed to be so thin that holes already appear in the baking linkage after the baking process. A condition for the hollow wafer baking mould according to the invention is that individual channels or engraving lines are present in the baking linkage which extend as far as the edge of the product space or the hollow wafer moulds and thus fulfil the function of removing the steam pressure peak in the first part of the baking process. Optionally for the mechanical stabilization of the baking linkage for the easy demoulding of the ready-baked wafer sheets, other, possibly deeper, channels or engraving lines and ribs or webs are provided with the property that they do not extend completely to the product space or to the hollow wafer half shell moulds.
b. There are no restrictions with regard to the baking masses. All conventional baking masses for hollow wafers are used.
c. The baking mass is metered for small-part hollow wafer shaped bodies such as possibly for pralines in a known manner in linear form. Application to the centre of the dome of the individual rows of hollow moulds is preferred in order to achieve a good moulding. If a few larger hollow wafer structures are to be baked, metering is preferably accomplished centrally onto the respective hollow wafer moulds.
d. The baking conditions on the automatic wafer baking machines do not differ significantly from those of known hollow wafer baking plates so that the person skilled in the art can easily set the baking temperature and the baking time according to his experience and these are comparable to the conventional conditions.
e. The demoulding of the baked hollow wafer half-shells and the baking linkage is accomplished according to one of the known methods either by means of gravity and conventional removal of the sheets or however by means of the vacuum removal thereof.
f. The demoulded product sheets are introduced into receiving carriers for the further process steps, which correspond to the contours of the sheets and the hollow wafer half-shells contained. The hollow wafer half-shells are in this case fixed with unambiguous orientation, either with the hollow side upwards (preferred) or with the raised side upwards. By pressing on a counter-plate which exactly simulates the contours of the hollow wafer half-shells, a clean separation of the baking linkage is made which is subsequently removed by means of one of the known methods such as scraping off, removal by vacuum, blowing off, where the hollow wafer half-shells are optionally held in the receiving carrier by means of vacuum.
g. The subsequent process steps can comprise: coating, applying a cream or chocolate film, metering of or covering with masses. Furthermore, the insertion of small-sized elements such as nuts, dried fruit and also extruded or baked pieces such as crispies or biscuits. The hollow wafer body is then combined in a known manner with a second similarly treated hollow wafer body or the flat open side of the filled hollow wafer half-shell is covered by inserting suitable flat wafer pieces or finished with coatings, decorations etc. and then supplied to cooling and packaging.

### SECOND METHOD EXAMPLE

### Flat Wafer Pieces with Closed Edge

Flat wafer pieces of predefined shape with largely closed edges are prepared in a similar manner to the described process of baking hollow wafer half-shells with largely closed edges.

In this case, there is the option merely to execute the edge contours in the range of a thickness of a few 0.1 mm in the flat wafer baking mould. In this case however, it is necessary for channels such as, for example, material bridges, engraving lines, ribs or webs to bridge or pass through these edge contours. The end result is similar to a separable puzzle.

If the desired figures cannot be represented as a closed structure in the flat wafer baking plate, it is provided similarly to the situation in the hollow wafer half-shells to provide a thin baking linkage therebetween with channels, engraving lines, ribs or webs.
a. Preparation of baking moulds for conventional flat wafer sheet automatic baking machines in which separating lines for subsequent separation of pieces of predefined shape are made significantly thinner or in addition, thin regions of a so-called baking linkage are provided, that is more than 50% thinner, preferably more than 70% thinner. The gap for the baking linkage can be designed to be so thin that holes already appear in the separating lines or in the baking linkage after the baking process. A condition for the hollow wafer baking mould according to the invention is that individual channels or engraving lines are present in the separating lines or in the baking linkage which extend as far as the edge of the separable flat wafer pieces and thus fulfil the function of removing the steam pressure peak in the first part of the baking process. Optionally for the mechanical stabilization of the baking linkage for the easy demoulding of the ready-baked structure, other, possibly deeper, channels, ribs, engraving lines and/or webs are provided with the property that they do not extend completely to the separable flat wafer pieces.
b. There are no restrictions with regard to the baking masses. All conventional baking masses for flat wafers are used.
c. The baking mass is metered in a known manner in linear form.
d. The baking conditions on the automatic wafer baking machines do not differ significantly from those of known flat wafer baking plates so that the person skilled in the art can easily set the baking temperature and the baking time according to his experience and these are comparable to the conventional conditions.
e. The demoulding of the baked flat wafer sheets is accomplished according to one of the known methods either by means of gravity with blowing assistance and conventional removal of the sheets or however by means of the vacuum removal thereof.
f. The demoulded product sheets are introduced into receiving carriers for the further production steps, which correspond to the contours of the sheets and the separating lines or baking linkages contained. By pressing on a counter-plate which exactly reproduces the contours, a clean separation of the flat wafer moulded pieces is made which are subsequently removed for further processing possibly by means of vacuum, or are optionally held so that residues of the baking linkage or the separating lines can be removed.
g. The subsequent process steps can comprise: coating, metering cream or other masses etc. Subsequently the flat wafer body is then combined in a known manner with a second similarly shaped flat wafer body or is finished with coatings, decorations etc. and then supplied to cooling and packaging.

### Exemplary General Process Scheme:

Preparation of a baking plate device or a hollow or flat wafer baking mould which, after baking, results in product sheets having separating lines and/or places with a thin baking linkage. The separating lines or the thin baking linkage are bridged by channels or engraving lines for removal of steam.

In addition, ribs or webs can be attached for stiffening the baking linkage. Baking takes place in a conventional automatic wafer baking oven. Additional complex process steps such as, for example, the opening of the baking plates during the baking process for removal of steam can be omitted.

Then:

Metering wafer baking masses in linear pouring, for larger hollow wafer half-shells also with centrally oriented point pourings per wafer half-shell.

Then:

Baking and demoulding wafer sheets which have easily separable shaped predefined by separating lines and/or places with thin baking linkage, which after separation only have a thin visually barely perceptible open edge. The demoulding is accomplished by conventional blowing out and removal, preferably however by means of vacuum removal methods.

Then:

The sheets obtained are optionally held in correspondingly pre-shaped receptacles. By combining with a counter-plate exactly reproducing the desired contours, a clean separation of the pre-moulded hollow or flat wafer pieces is accomplished.

Then:

Controlled transfer to the further process steps such as possibly coating, metering, spreading, insertion etc. directly following.

The invention is explained further hereinafter with reference to specific exemplary embodiments.

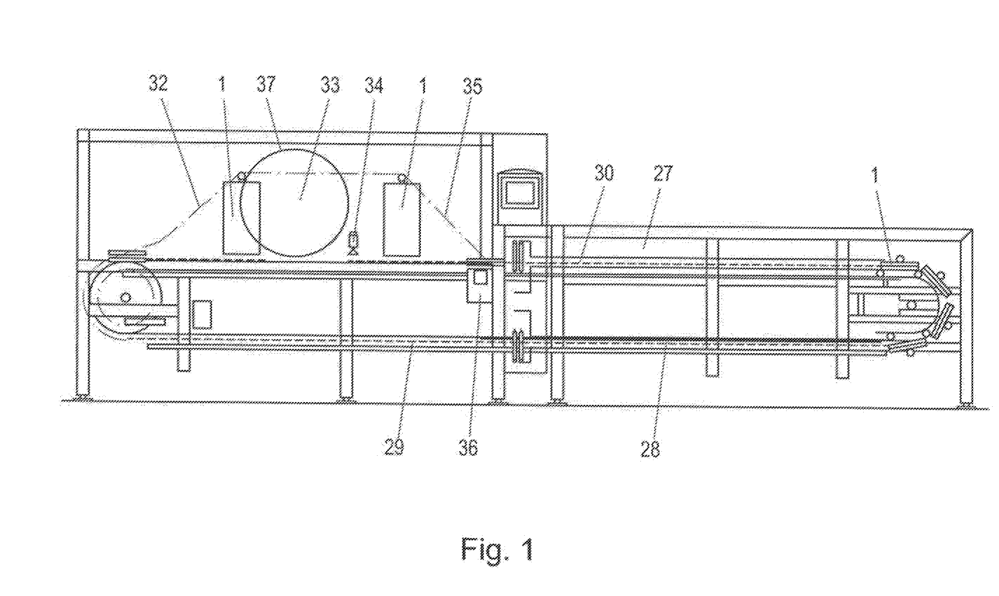

FIG. 1 shows a schematic view of a baking oven according to the invention which in particular is configured as an automatic wafer sheet baking oven for the industrial production of baking products. The oven comprises a baking chamber 27 which can be heated or is heated by conventional means. Furthermore, an endless baking tong chain 28 is provided which in particular runs through the baking chamber 27. The baking tong chain 28 is disposed along an orbit which is closed in itself, which preferably extends in two superposed transport planes 29 and 30. The baking tong chain 28 contains baking tongs 1. These are designed to be openable and closable and in particular can be locked in the closed state. In the schematic diagram in FIG. 1 only a few selected baking tongs 1 are shown for reasons of clarity. Usually the baking tongs 1 run in a strung-together manner along the entire baking tong chain 28. The baking oven comprises a device 32 for opening and closing the baking tongs 1. This device 32 is in particular designed as a linkage control which engages in a control unit of the baking tong pair in order, for example, to separate the upper baking plate from the lower baking plate and thereby open the baking tong. Furthermore the baking oven comprises a feeding station 34. In this feeding station 34 the batter is introduced into the baking tongs 1. This can be accomplished, for example, by a transversely running feed unit which is opened with holes at regular intervals. By supplying the batter through this feed unit, the batter is applied to one of the baking plates at predefined spacing. A device 35 for closing the baking tongs 1 is provided downstream of the feeding station. This device 35 for closing can also, for example, be designed as a linkage control.

Located downstream of the said feature, a locking device 36 of the baking oven is provided for locking the baking tongs. Furthermore, the baking oven comprises a discharge station 33. A product removal device 37 is provided in the discharge station 33 via which the ready-baked wafer shaped bodies can be removed from the baking tong 1. In this discharge station the wafer sheets are removed from the baking tongs. The product removal device 37 is shown schematically as a circle. For example, negative pressure means can be provided on a drum or on a rotating frame, by which means the wafer sheets can be removed. In contrast to soft waffles, during the removal of crispy brittle wafers such as are produced in the method according to the invention, care should be taken to ensure that no breaking of the wafer shaped body i.e. of the wafer sheet takes place during removal.

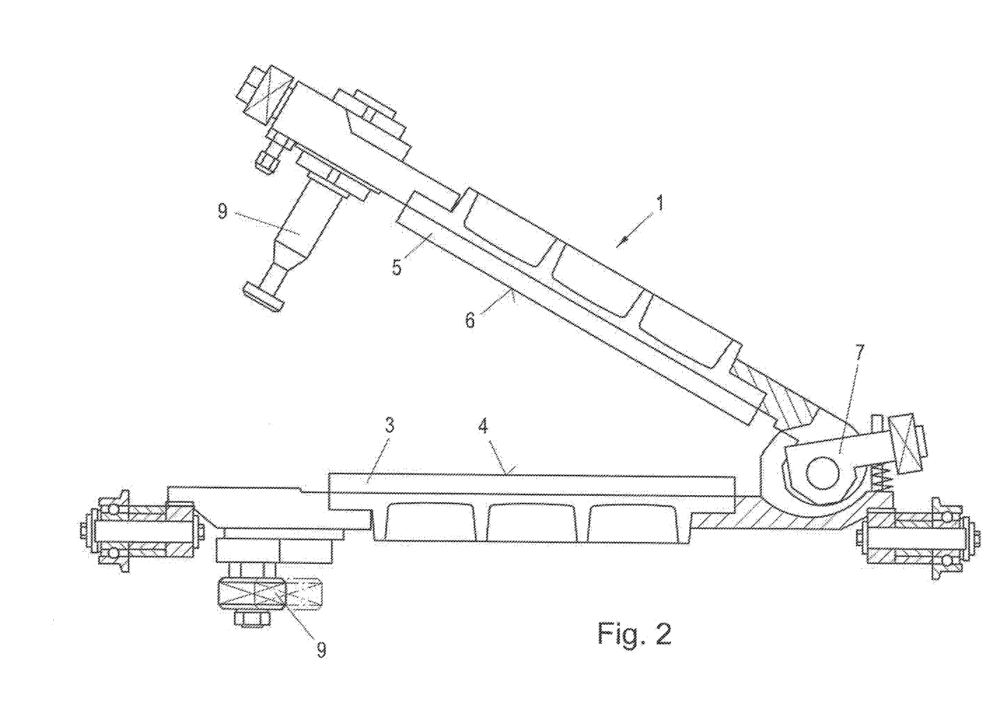

FIG. 2 shows a schematic view of a baking plate apparatus according to the invention, which is designed as baking tongs 1. The baking plate apparatus comprises a first baking plate 3 having a first baking surface 4 and a second baking plate 5 having a second baking surface 6. The baking plates are connected to one another in an openable and closable manner by means of a movement apparatus 7. In the present case the movement apparatus is designed in particular as a hinge joint. The baking plates 3, 5 can be connected to one another in a hinge-like manner to form the baking plate apparatus itself or be connected to a support which takes over the hinge function. To this end a frame is provided which can be opened in a hinge-like manner. The baking plates 3, 5 are provided on this frame in a known manner.

Furthermore the baking plate apparatus comprises a locking apparatus 9. This locking apparatus 9 enables the locking of the baking plates 3, 5 with respect to one another in the closed state. In order to produce crispy brittle wafers which are baked under pressure, it is absolutely necessary that a locking apparatus is provided. This is in particular necessary so that pressure can build up between the two baking plates 3, 5. In the present embodiment the locking apparatus 9 comprises a mushroom-shaped pin which is rigidly connected to one of the plates. The respectively other plate has a receptacle for the mushroom-shaped pin. If the pin is inserted into the receptacle, withdrawal of the pin can be prevented by means of a locking element. This locking is preferably accomplished by a linkage control.

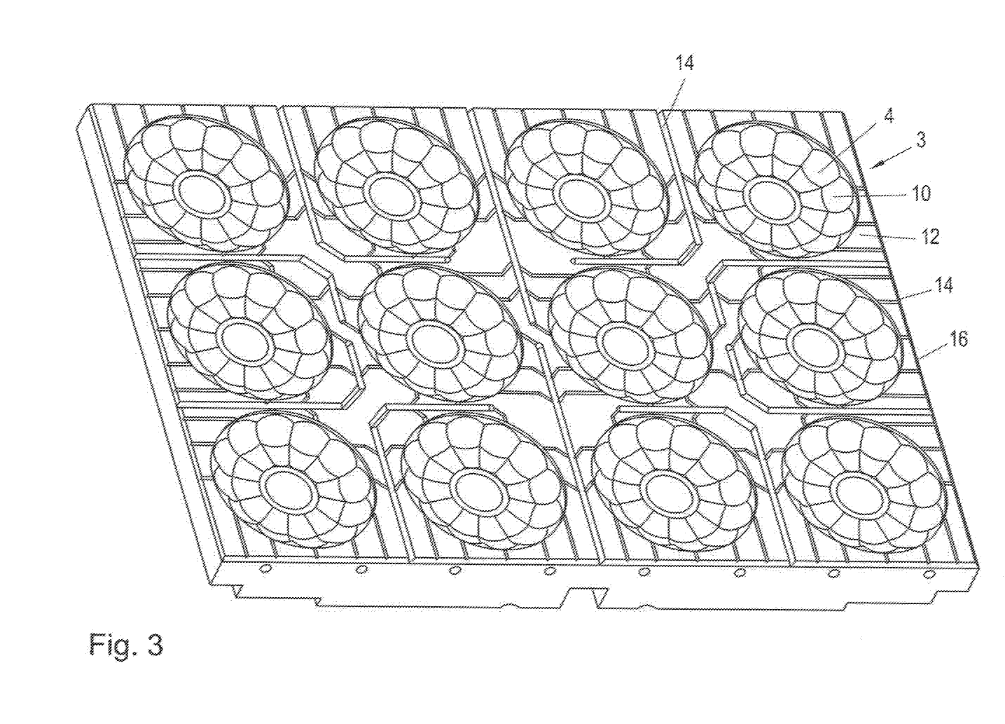

FIG. 3 shows an embodiment of a baking plate according to the invention. This baking plate corresponds, for example, to a lower or upper plate of the baking plate apparatus.

For clarity it is defined that the depicted plate is the first baking plate 3 having a first baking surface 4. The baking surface 4 corresponds to that surface of the baking plate 3 which faces the second baking plate 5 in the closed state. The first baking plate 3 forms a baking mould 8 with the second baking plate 5 in the closed state. In order to improve the clarity, in the present view in FIG. 3, the second baking plate 5 is omitted. A baking mould 8 is formed by the first baking plate which at least comprises a product space 10. In the present view, three times four, i.e. twelve product spaces 10 are provided. In the area of the product space the baking plate has a trough-shaped recess. The trough-shaped recess is at least partially filled with the baking mass during the production of the wafer shaped body.

Further, the baking plate pair and in particular the baking mould 8 comprises a gap section 12. This gap section 12 surrounds the product space 10. Channels 14 are provided in the gap section 12. The channels are used in particular to remove the steam formed during the baking process. The steam is especially guided onto the outer side 16 of the baking plate 3 where the steam can escape from the baking plate apparatus. The channels 14 extend in this case from the product space 10 through the gap section 12 outwards. Optionally the channels 14 open into the product space or extend as far as the edge of the product space. The channels preferably pass through the gap section 12. This means, for example, that the channel opens the product space 10 outwards. In the present embodiment the channels 14 are designed as engravings of the baking plate or the first baking surface 4. For example, the channels 14 are designed as engravings of the baking surface in the gap section 12. According to a further embodiment however, the channels can also be designed as bores inside the baking plate.

Optionally several channels 14 are combined and open into a channel which is open towards the outside.

According to another embodiment not shown, one channel opens into two product spaces 10 and thus connects the product spaces 10 to one another. In the embodiment shown the steam is removed from a product space 10 via several channels 14. To this end several channels 14 open into a product space 10. Preferably the channels 14 distributed regularly on the circumference of the product space 10 open into the product space. A uniform removal of the steam is thereby achieved.

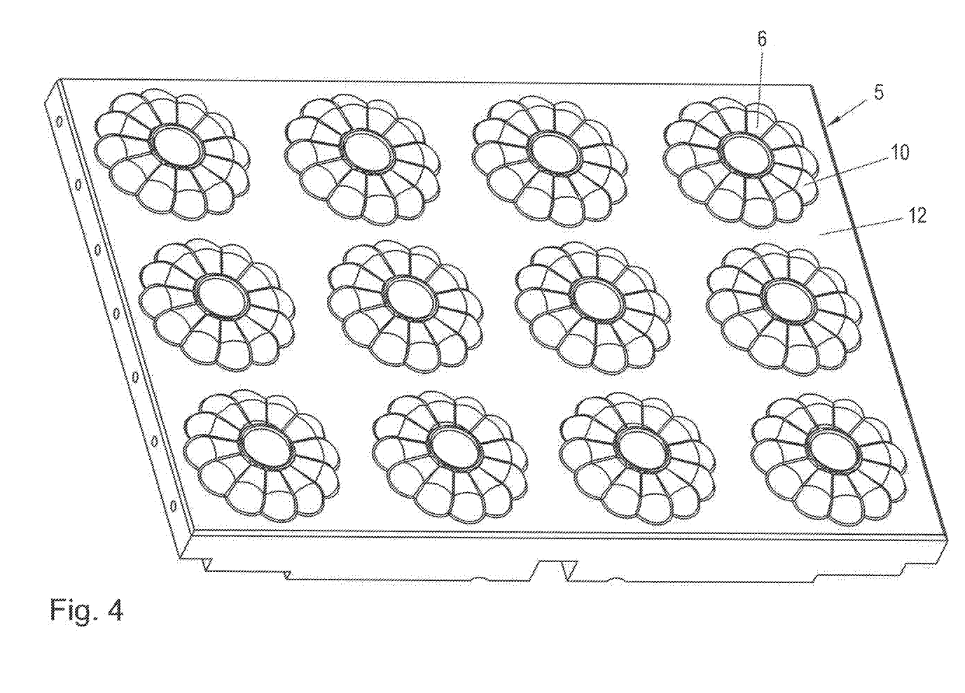

FIG. 4 shows a possible counter-plate, in particular a second baking plate 5 to the first baking plate 3 in FIG. 3. The second baking plate 5 has a second baking surface 6. In the closed position a baking mould 8 is formed by the first baking plate 3 and the first baking surface 4 thereof and the second baking plate 5 and the second baking surface 6 thereof, To improve clarity, the first baking plate 3 and the second baking surface 4 are blanked out and not shown. The baking mould 8 which comprises a product space 10 and a gap section 12 is again provided. In the present embodiment, the second baking surface 6 of the second baking plate 5 is designed to be substantially smooth in the gap section and has no engraving or no channel. However, the channel 14 is formed by the first baking plate 3 comprising a channel. Consequently, the channel runs in the first baking plate 3 upon combining the first baking plate of FIG. 3 and the second baking plate of FIG. 4.

According to an embodiment of the invention which is not shown however, channels 14 can be provided in both baking plates, i.e. in the first baking plate 3 and in the second baking plate 5. According to the invention, these channels can be designed as engraving in the baking surface or as a bore. In the present embodiment of FIG. 4, the second baking plate 5 in the product space 10 comprises arched, hump-shaped product surfaces.

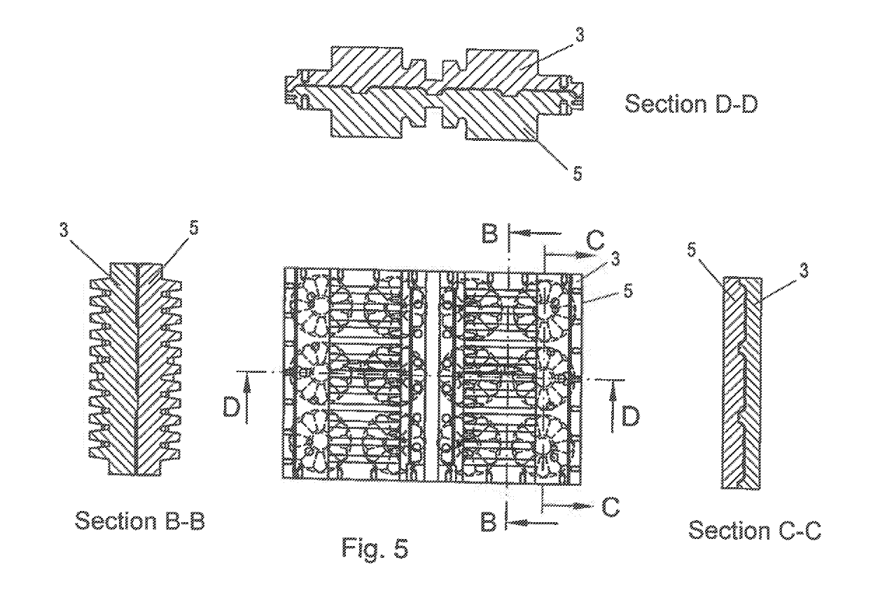

FIG. 5 shows a schematic top view of an embodiment of the baking plate apparatus according to the invention as well as three sections running along the lines of intersection B-B, C-C and D-D.

The cutaway and schematically depicted baking plate apparatus substantially corresponds to the baking plate apparatus from FIGS. 3 and 4.

A first baking plate 3 and a second baking plate 5 are provided. The sectional views are further discussed in the following figures.

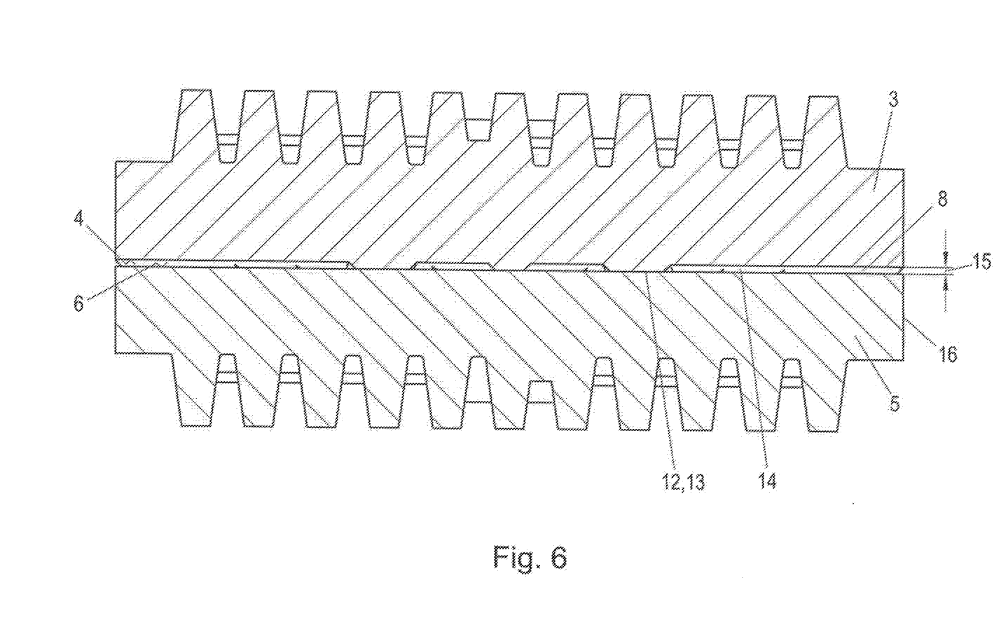

FIG. 6 shows the section B-B from FIG. 5. To this end, the first baking plate 3 and the second baking plate 5 are shown cutaway. The baking mould 8 is provided between the two baking plates 3, 5. The baking plate 3 has a first baking surface 4. The second baking plate 5 has a second baking surface 6. In the folded-together position the baking surfaces 4, 6 point towards one another and together form the baking mould 8. In the schematic sectional view of FIG. 6, the section as a whole runs through the gap section 12. The product space 10 is not cutaway. The gap section 12 has a gap thickness 13. In the present view this gap thickness is substantially zero. Thus, the first baking surface 4 is placed directly on the second baking surface 6. As a result of the evolution of pressure during baking of the wafer shaped body, however, removal can be effected by elastic deformation of the baking plates. In this case, a gap thickness 13 greater than zero is present.

In principle, the distance between the first baking surface 4 and the second baking surface 6 is designated as thickness. In the product the thickness corresponds to the distance between the surface of the wafer shaped body which is formed by the first baking surface, and the second surface of the wafer shaped body, which is formed by the second baking surface. Furthermore channels 14 are provided in the gap section 12. The channels 14 have a channel thickness 15. The channel thickness 15 here is greater than the gap thickness 13. The channels 14 are preferably guided onto the outer side of the baking plates. As a result, the product space and the channel 14 are open towards the outside.

The sectional views of FIGS. 5 to 8 of the baking plate apparatus are shown simplified. In particular, all the elements except for the baking plate pair are blanked out.

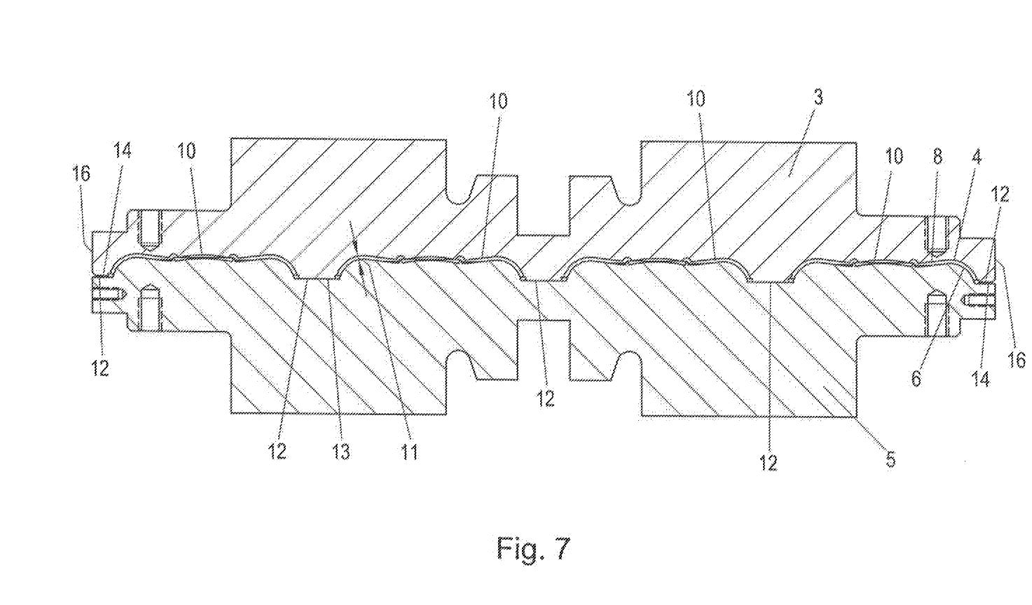

FIG. 7 shows a schematic sectional view along the sectional line D-D. The section runs through the first baking plate 3 and the second baking plate 5. A baking mould 8 is formed between the baking plates 3, 5 and the baking surfaces 4 and 6 thereof.

The line of intersection D-D runs through one or more gap sections 12 and through one or more product spaces 10. Furthermore, channels 14 are provided which open the product space 10 towards the outside. The channels 14 pass through the gap section 12. As a result, the product space 10 is open towards the outside. In particular, the channels run as far as the outer side 16 of the baking plate pair. The product space 10 has a product thickness 11. This product thickness 11 is substantially constant over the entire product space 10. The gap section 12 has a gap thickness 13 which in the present view is substantially zero. According to a preferred embodiment of the invention, the gap thickness 13 is at least 50% smaller than the product thickness 11. Particularly preferably there is a 70% reduction in the gap thickness compared with the product thickness. Possibly the gap thickness can be zero at least in sections.

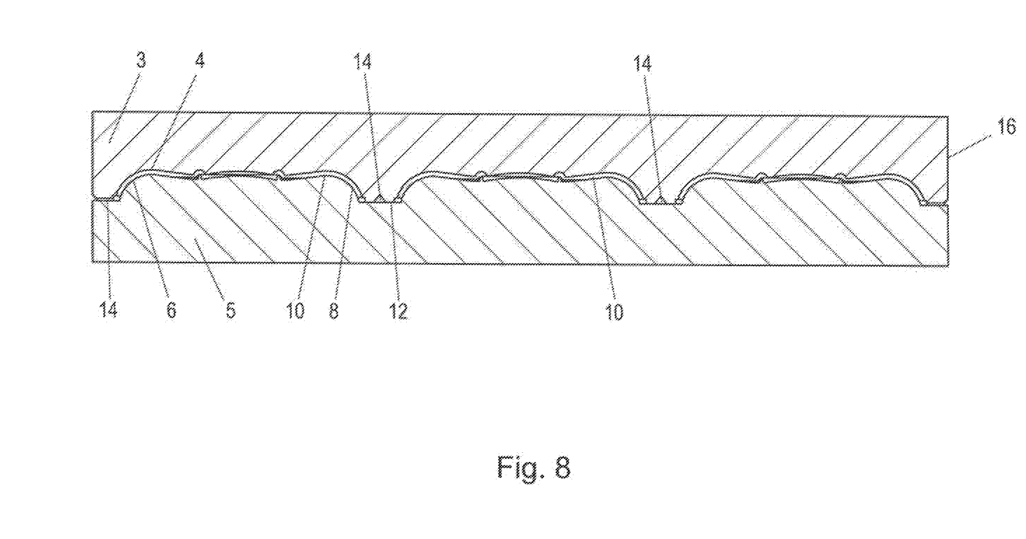

FIG. 8 shows a schematic sectional view of the section along the line of intersection C-C from FIG. 5. The simplified sectional view shows a first baking plate 3 with a first baking surface 4 and a second baking plate 5 with a second baking surface 6. A baking mould 8 is formed by bringing together the first and the second baking plate as well as the baking surfaces thereof. The baking mould 8 comprises one or more product spaces 10 and interposed gap sections 12. The gap sections 12 are penetrated by channels 14. In the area between two product spaces 10, respectively one channel is cut normally to its longitudinal extension. In the present embodiment of FIG. 8 the channel is executed as a substantially V-shaped engraving which runs in the first baking plate 3. According to a further embodiment however, the channels 14 can also run in both or only in the second baking plate 5. Preferably the channels 14 interconnect two product spaces 10 or run from the product space 10 onto the outer side 16 of a baking plate pair.

In order to product the wafer shaped bodies according to the invention, in the baking method according to the invention at least the product space 10 but preferably the entire baking mould 8 is filled with a baking mass. The baking mass is substantially liquid to viscous and thus coats the baking mould 8. As a result of the baking process and the escape of steam, a substantially crispy brittle wafer shaped body is formed having a porous crumb. The surfaces of the wafer shaped body which rest against the first baking surface 4 or against the second baking surface 6 have a substantially closed baking skin. The baked product is formed here by the product space 10. At least one, preferably several connecting lamellae are formed by the gap section 12. One or more ribs are formed by the channels 14. Those regions of the baking mould 8 located between the product spaces 10 form the baking linkage of the wafer shaped body. According to the present method, this baking linkage is removed to form the finished baked products.

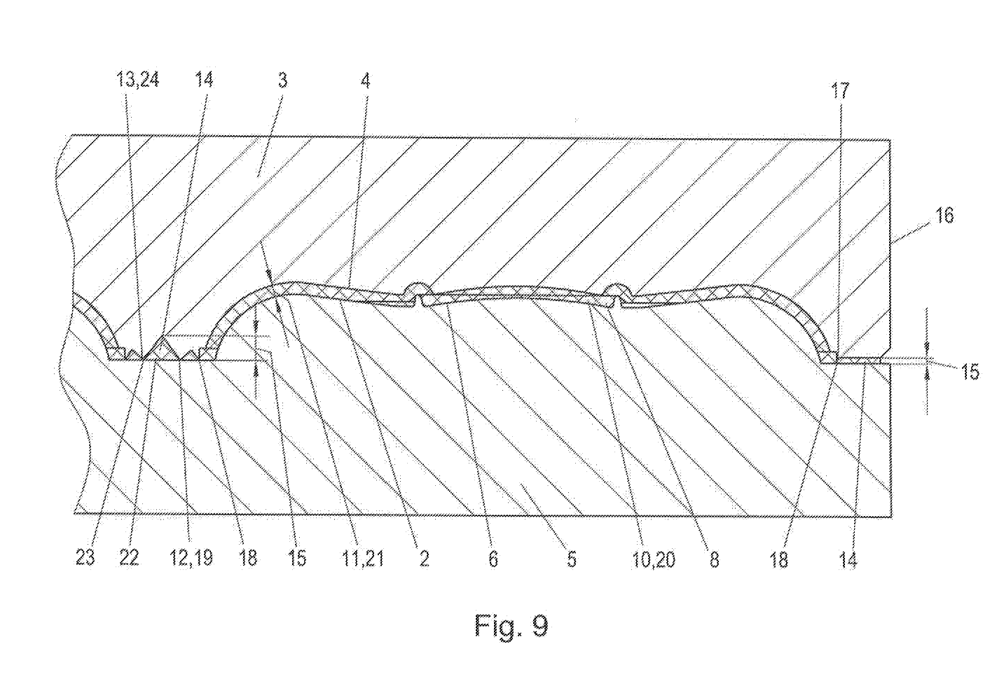

FIG. 9 shows a detail of a baking plate pair filled with baking mass which in particular corresponds to the baking plate pair from FIG. 8. In particular, the sectional view of FIG. 9 is a detailed sectional view of the diagram of FIG. 8 with a wafer shaped body 2. This wafer shaped body 2 is formed by the first baking plate 3 and the second baking plate 5. The first baking surface 4 and the second baking surface 6 together form a baking mould 8 which in the present view is completely filled by the wafer shaped body 2. The baked product 20 is disposed in the product space 10. The baking linkage 19 is formed in the gap section 12. The baking linkage 19 comprises a connecting lamella 23 and ribs 22. The product thickness 11 substantially corresponds in the present view to the baked product thickness 21. The gap thickness 13 in the present view substantially corresponds to the lamella thickness 24. In the present view this is almost zero. According to a preferred embodiment the lamella thickness is approximately 0.1-0.8 mm thick. The channel thickness 15 can be differently dimensioned for different channels. For example, by combining several channels 14 it can be necessary that individual channels are designed to be thicker than others. In particular, it is necessary that these have a larger cross-section. Preferably the channel thickness 15 is greater than the gap thickness 13. The channel thickness 15 in this region in any case substantially corresponds to the thickness of the rib 22. In the region of the transition between the gap section 12 and the product space 10, a pre-determined breaking line 18 is provided. In the present embodiment this pre-determined breaking line is cut and thus shown as running in a substantially projecting manner. This is achieved in the region of the transition between the channel and the product space, for example, whereby during production of the engraving to form the channel 15 the milling head is stopped shortly before completely penetrating the edge of the gap section 12. A comb 17 is thus formed. This comb 17 of the baking plate forms a pre-determined breaking line 18 in the baking process according to the invention.

In the region of the transition between a smooth gap section without channel, the pre-determined breaking line is provided by making the lamella thinner and more brittle than the baked product.

The product thickness 11 is substantially constant over the entire profile of the baked product 20 or over the profile of the product space 10. As a result a uniform baking of the baked product is achieved. On the other hand, the thickness of the gap section 12, i.e. the gap thickness 13, is smaller than the product thickness 11.

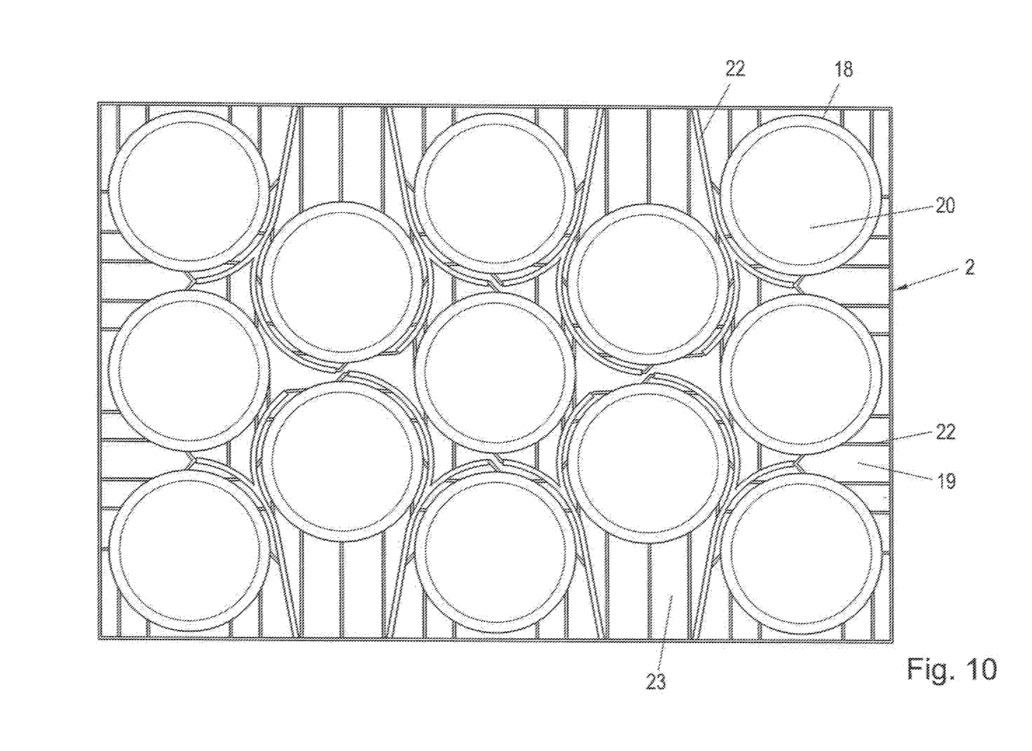

FIG. 10 shows an exemplary embodiment of a wafer shaped body 2 according to the invention. This is a baked intermediate product to produce the baked product 20. Several baked products 20 are contained in the wafer shaped body 2. The baked products 20 are surrounded by a baking linkage 19. As already described, the baking linkage 19 is formed by that region of the baking plates which is designated as gap section. The baking linkage 19 comprises ribs 22. These ribs 22 run, for example, from the edge of the baked product 20 as far as the edge of the wafer shaped body 2. Preferably a plurality of ribs 22 are provided. Optionally a plurality of ribs in the course of the baking linkage are combined to form a wider or thicker rib. The ribs are used to remove the steam during the baking process. In the finished wafer shaped body the ribs are used for stiffening the wafer shaped body. In particular, this facilitates a removal from the baking tongs. To this end, at least two, preferably a plurality of ribs 22 are disposed running obliquely to one another. This avoids pre-determined breaking points being formed by the ribs in the baking linkage. According to the present embodiment, the ribs have a substantially triangular cross-section. However, by providing differently shaped channels or engravings of the wafer baking plates, the ribs can also have different cross-sections such as, for example, semi-circular, rectangular, web-shaped, strip-shaped or slot-shaped.

The connecting lamellae 23 are disposed between the baked products 20 and optionally connect these. The ribs 22 preferably run in the area of the connecting lamellae 23. The baked product show is configured to be a substantially round, cup-shaped body. By breaking according to the invention along the pre-determined breaking line 18, the baked products 20 have a substantially closed edge. The pre-determined breaking line 18 runs in the embodiment shown in a circular manner directly adjoining the baked product 20.

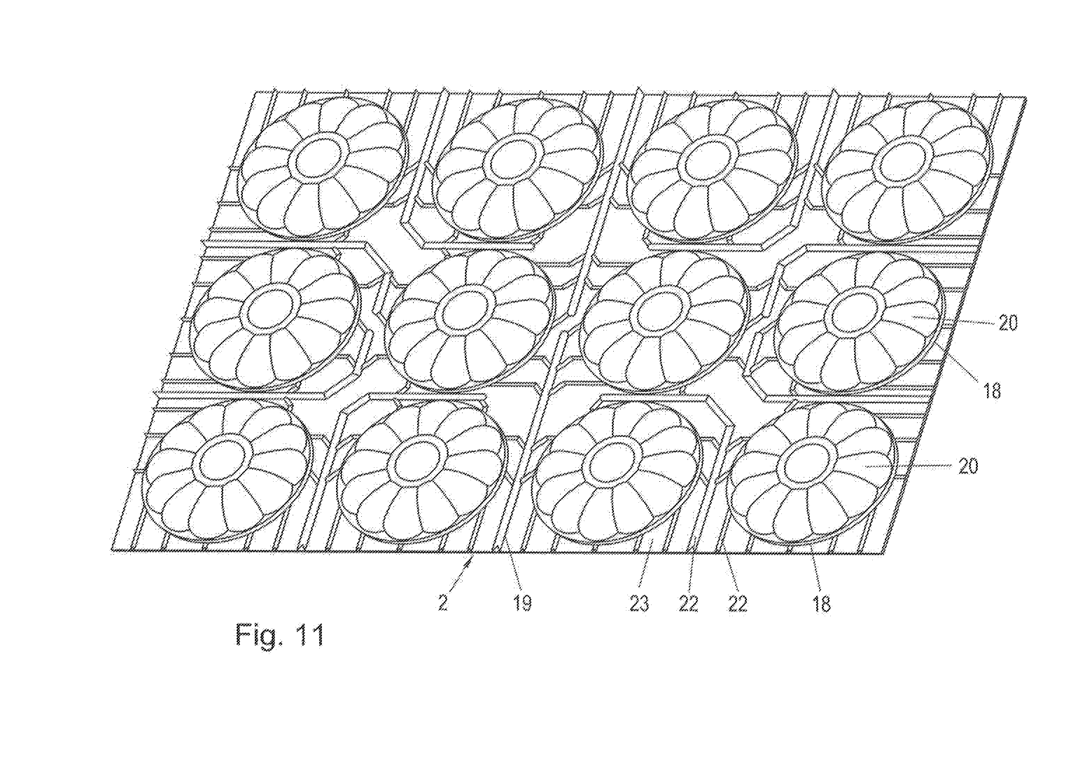

FIG. 11 shows another embodiment of wafer shaped body 2 according to the invention, such as can be produced for example using the baking plates of FIGS. 3 to 9. The wafer shaped body 2 comprises a baking linkage 19 which comprises ribs 22. Optionally or preferably the baking linkage 19 comprises a connecting lamella 23. The baked products 20 are interconnected by a baking linkage 19. The ribs 22 run from the edge of the baked products 22 to the outer edge of the wafer shaped body 2.

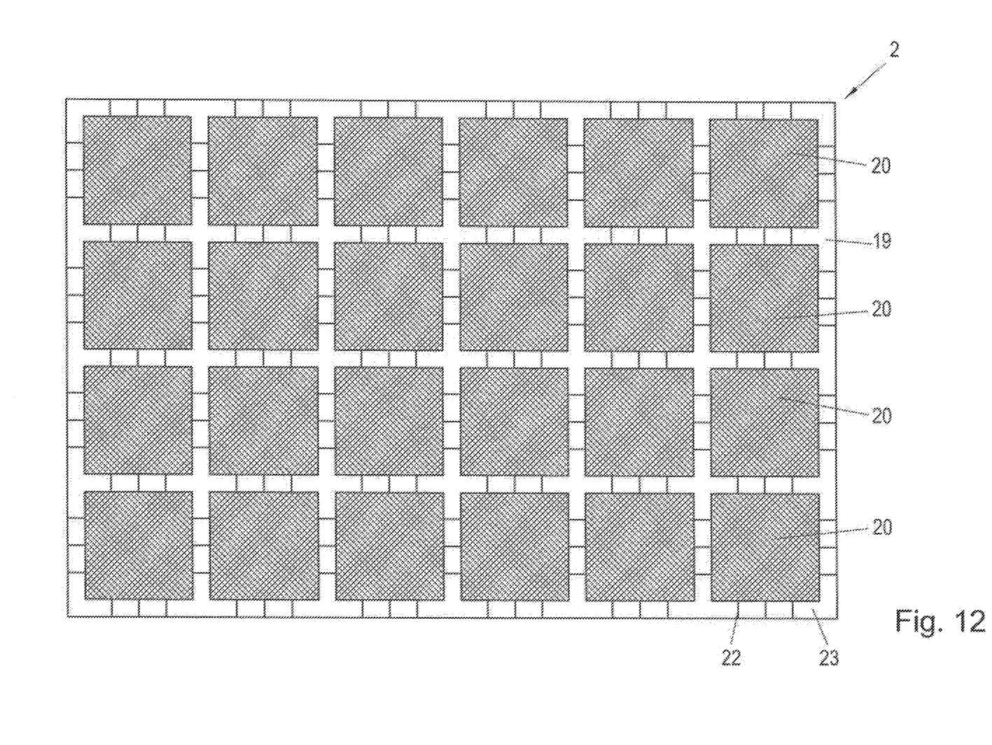

FIG. 12 show another embodiment of a baked product according to the invention or a wafer shaped body 2 according to the invention. In this case, the wafer shaped body in turn comprises a plurality of baked products 20. The baked products 20 are configured as flat wafers. These flat wafers have a relief-like, in particular mesh-like surface structure as is usual for flat wafers. This structure is achieved by a mesh-like engraving of the baking plates. The individual baked products are interconnected via a baking linkage 19. The baking linkage 19 comprises on the one hand ribs 22 and optionally or preferably connecting lamellae 23. The ribs 22 run on the one hand from baked product to baked product and on the other hand from the baked product 20 to the outer edge of the wafer shaped body 2. The appurtenant baking plates have a complementary engraving and a complementary baking mould. The product thickness of the baked product 20 is according to the invention greater than the lamella thickness of the connecting lamellae.

For wafers having a relief-like structure this fundamentally means that the core thickness of the baked product 20 is thicker than the lamella thickness of the connecting lamella. The core thickness describes the thickness of a body which extends continuously through the baked product. This is substantially that thickness which remains if the relief-like structure of the wafers were to be removed. This basically applies to all embodiments of the invention having a relief-like surface structure typical of wafers. However, this relief-like surface structure should not be equated to the open-pore structure of the crumb of a separating surface. On the contrary, the closed baking skin is designed in a meandering relief-like manner.

In this embodiment, the ribs 22 are thicker than the connecting lamella. As a result, the stability of the finished wafer shaped body is increased on the one hand and on the other hand, transport of steam during baking is made possible.

According to a further embodiment, the connecting lamella 22 can be made very thin so that the baked products 20 almost abut against one another. The connecting lamellae are thus configured as groove-shaped constrictions of the wafer shaped body. However, these groove-shaped constrictions of the wafer body are penetrated by ribs 22 so that the steam can be removed during baking. Along these groove-shaped connecting lamellae, the wafer shaped body can be divided into the finished baked products 20. With a groove-shaped configuration of the lamella however, almost no baking linkage 19 is provided. Nevertheless, the effect according to the invention occurs in that the baked products are substantially closed at the edges since the closed baking skin of the top side and the closed baking skin of the underside are substantially combined.

### REFERENCE LIST

1 Baking tong
2 Wafer shaped body
3 First baking plate
4 First baking surface
5 Second baking plate
6 Second baking surface
7 Movement apparatus
8 Baking mould
9 Locking apparatus of the baking plate
10 Product space
11 Product thickness
12 Gap section
13 Gap thickness
14 Channel
15 Channel thickness
16 Outer side of baking plate
17 Comb
18 Pre-determined breaking line
19 Baking linkage
20 Baked product
21 Baked product thickness
22 Rib
23 Connecting lamella
24 Lamella thickness
25 -
26 Core region of the wafer shaped body
27 Baking chamber
28 Baking tong chain
29 Transport plane
30 Transport plane
31 -
32 Device for opening the baking tongs
33 Discharge station
34 Feeding station
35 Device for closing the baking tongs
36 Locking apparatus of the baking oven for locking the baking tongs
37 Product removal apparatus

1-26. (canceled)

27. A baking plate apparatus for producing wafer shaped bodies baked under pressure, comprising:
a first baking plate having a first baking surface;
a second baking plate having a second baking surface;
a movement apparatus by which said first baking plate is connected to said second baking plate in an openable and closable manner;
a locking apparatus for locking said first baking plate to said second baking plate in a closed position; and
wherein in the closed position a baking mold is formed by said first baking surface and said second baking surface which substantially corresponds to a negative form of a wafer shaped body, said baking mold having a product space defining a product thickness, and surrounded by a gap section with a gap thickness, said gap thickness is smaller than the product thickness, said baking mold further having at least one channel formed therein and having a channel thickness provided for removal of steam and penetrating said gap section, said channel thickness being greater than said gap thickness.

28. The baking plate apparatus according to claim 27, wherein said channel extends from said product space as far as an outer side of said baking plates and thereby opens said product space towards an outside.

29. The baking plate apparatus according to claim 27, wherein said product space is one of at least two product spaces formed in said baking mold and said channel extends from one of said product spaces to another of said product spaces and thereby connects said two product spaces with one another.

30. The baking plate apparatus according to claim 27, wherein said channel penetrates said gap section along at least one of said first baking surface or said second baking surface.

31. The baking plate apparatus according to claim 27, wherein said channel is provided as a linear engraving in at least one of said first or second baking surfaces of said first and second baking plates, said linear engraving crosses said gap section.

32. The baking plate apparatus according to claim 27, wherein said gap thickness of said gap section is less than 50% of the product thickness and/or said gap thickness is zero at least in sections.

33. The baking plate apparatus according to claim 27, wherein:
said product space is one of a plurality of product spaces; and
said gap section extends flat between said product spaces and/or between one said product space and an outer side of a pair of said baking plates.

34. The baking plate apparatus according to claim 27, wherein said product space is one of a plurality of product spaces and two of said product spaces are connected to one another via said gap section.

35. The baking plate apparatus according to claim 27, wherein said channel is one of a plurality of channels opening into one said product space.

36. The baking plate apparatus according to claim 27, wherein said channel is one of a plurality of channels being combined in said gap section.

37. The baking plate apparatus according to claim 27, wherein said channel is one of a plurality of channels distributed substantially regularly on a circumference of said product space and open into said product space.

38. The baking plate apparatus according to claim 27, wherein said channel is one of a plurality of channels running obliquely with respect to one another so that the wafer shaped body has a stable structure.

39. The baking plate apparatus according to claim 27, wherein said product space has a substantially closed comb constricting the product space so that the wafer shaped body has a pre-determined breaking line for separation of a baked product from the pre-determined baking linkage.

40. A wafer shaped body, comprising:
a baking mass baked under pressure and containing 55-70% water in the unbaked state, said baking mass having a baked product with a baked product thickness and surrounded by a baking linkage, said baking linkage containing at least one rib extending as far as an edge of said baked product.

41. The wafer shaped body according to claim 40, wherein said baking linkage has a connecting lamella with a lamella thickness, said lamella thickness is at least 50% smaller than the baked product thickness or is zero at least in some sections.

42. The wafer shaped body according to claim 41, wherein said rib runs in a surface of said connecting lamella.

43. The wafer shaped body according to claim 40, wherein said rib extends from said baked product as far as an edge of said baking mass.

44. The wafer shaped body according to claim 40, wherein said rib is one of a plurality of ribs distributed substantially regularly on a circumference of said baked product, and opening into said baked product.

45. The wafer shaped body according to claim 41, wherein said baking mass has a pre-determined breaking line surrounding said baked product and having a smaller thickness than said baked product.

46. The wafer shaped body according to claim 40, wherein said baked product is one of a plurality of baked products which are connected to one another by said baking linkage.

47. The wafer shaped body according to claim 46, wherein said least one rib connects two of said baked products to one another.

48. The wafer shaped body according to claim 40, wherein said baked product thickness is between 0.5 mm to 5 mm and has a continuous core region with a thickness of about 0.5 mm to 2 mm.

49. The wafer shaped body according to claim 45, wherein regions of smaller thickness such as said connecting lamella and/or said pre-determined breaking line have a higher degree of baking than said baked product, and are over baked and that said regions having the higher degree of baking are more brittle than said baked product.

50. A baking oven for producing crispy-brittle baked wafer shaped bodies, the baking oven comprising:
a baking chamber;
an endless baking tong chain circulating continuously in the baking oven and moving through said baking chamber, said endless baking tong chain being disposed along an orbit which is closed in itself and which extends in two transport planes disposed one above another, said endless baking tong chain containing openable and closable baking tongs being lockable in a closed state, said baking tongs containing baking molds having baking mold upper parts and baking mold lower parts, said baking molds being opened by opening said baking tongs and are closed by closing said baking tongs;
a device for opening said baking tongs, a discharge station, a feeding station, a device for closing said baking tongs and a locking apparatus for locking said baking tongs in the closed state are disposed one behind another in a running direction of said baking tongs;
a product removal apparatus for removing a baked wafer shaped body from said baking tongs being open and disposed in said discharge station,
said baking tongs, each containing:
a first baking plate having a first baking surface;
a second baking plate having a second baking surface;
a movement apparatus by which said first baking plate is connected to said second baking plate in an openable and closable manner;
a locking apparatus for locking said first baking plate to said second baking plate in a closed position; and
wherein in the closed position said baking mold is formed by said first baking surface and said second baking surface which substantially corresponds to a negative form of a wafer shaped body, and wherein said baking mold having a product space defining a product thickness, and surrounded by a gap section with a gap thickness, wherein said gap thickness is smaller than the product thickness, said baking mold further having at least one channel having a channel thickness provided for removal of steam, penetrating said gap section, wherein said channel thickness is greater than said gap thickness.

51. A method for producing crispy-brittle baked products, which comprises the following steps of:
metering wafer baking masses via linear pouring or with centrally oriented point pouring into a baking mold of a baking plate according to claim 27;
baking and demolding the wafer shaped bodies by blowing out and removing or vacuum removal methods; and
separating the wafer shaped bodies from a baking linkage along a predetermined breaking line.

52. The method according to claim 51, wherein for separating the wafer shaped bodies from the baking linkage, the wafer shaped bodies are:
supplied to a separating apparatus which contains a separating mold which contacts the wafer shaped bodies at least in a region of predetermined breaking lines; and
separating the wafer shaped bodies via at least one stamp which brings about a relative movement between the wafer shaped bodies and the baking linkage.
